(19) United States
(12) Patent Application Publication
(10) Pub. No.: US 2009/0133442 A1
(43) Pub. Date: May 28, 2009

(54) Glass Cutting with Gas Burner and Cooling Spray

(76) Inventor: Joachim Bretschneider, Weiden (DE)

Correspondence Address: MARSHALL & MELHORN, LLC, FOUR SEAGATE - EIGHTH FLOOR, TOLEDO, OH, 43604, US

(21) Appl. No.: 11/992,271

(22) PCT Filed: Sep. 18, 2006
(86) PCT No.: PCT/EP2006/009058

§ 371 Date: Mar. 18, 2008

(30) Foreign Application Priority Data
Sep. 20, 2005 (GB) 0519111.9

(51) Int. Cl. C03B 21/02

(52) U.S. Cl. 65/113; 65/176; 65/112

(57) ABSTRACT

An apparatus and a method for cutting float glass is disclosed. A burner and water spray are arranged to cause thermal stress cracking along a cutting line extending along a continuous glass ribbon, parallel with the edge of the ribbon. The thermal stress cracking is initiated without the use of mechanical force. Preferably, the burner is used to initiate the thermal stress crack, by increasing the power supplied to the glass.

This invention relates to the cutting of glass, and in particular to the cutting of float glass.

The float process for the manufacture of glass is well known. Raw materials are mixed and fed onto molten glass in a melting furnace. Once melted, refined and homogenized, the molten glass leaves the furnace and flows out onto the surface of a float bath of molten tin, where it spreads across the surface of the molten tin and cools, forming a continuous glass ribbon. At this point, the glass may be coated if desired. The continuous ribbon of glass then flows over a series of lehr rollers where it is closely temperature controlled and annealed. Finally, the glass is inspected, passes under a series of cross-cutters and cut to size.

Although use of the float process results in high quality, near optically perfect glass, the edges of the ribbon remain stressed even after annealing, and are cut off as selvedge. One method of trimming off the selvedge is to use diamond wheel cutters positioned near the edge of the continuous glass ribbon. Selvedge removal equipment is then used to break off the edge of the glass along the score line. As an alternative to diamond wheel cutters, mechanical or thermal stresses can be used to induce a crack in the glass, which is then either snapped or cut.

U.S. Pat. No. 3,909,226 discloses a method of cutting an elongated strip of glass by modifying the stress pattern in the region of a strip to be cut. A line of tensile stress is formed in the strip between a cutting line and the edge of the sheet of glass, and a line of compressive stress is formed along the cutting line. By changing the stress distribution, the quality of a mechanical cut can be improved.

U.S. Pat. No. 4,828,900 discloses a method of cutting a float glass ribbon, prior to annealing. A cutting line is heated to softening temperature by burners arranged across the glass ribbon, and a blade used to sever the glass along the cut line. EP 1 177 155 discloses the use of a heated blade and/or a laser to cut the edge of a glass ribbon before leaving the float bath. WO2005/054142 discloses the use of a linear burner to cut float glass, but requires mechanical force to initiate the crack, in the form of a cutter.

Other cutting mechanisms for use with glass, although not necessarily for cutting along the edge of a ribbon, involving induced thermal or mechanical stresses are also known. For example, DE 28 13 302 discloses a method of scribing a glass sheet by continuously heating a first part of a glass substrate and simultaneously cooling a second part of the substrate by convection or conduction. A crack in the glass is initiated using a sharp cut.

EP 0 872 303 discloses the use of a laser to cut curved shapes out of flat glass workpieces. A scanning laser is reflected from a mirror onto the workpiece and creates a U- or V-shaped profile. The profile has a greater intensity in the outer regions, and a maximum intensity at the rear of the profile. The laser is passed over the surface of the glass along a cutting line which is subsequently cooled. The thermal stress created by the laser and subsequent cooling creates a crack without the need to use additional mechanical force or stress to initiate the crack.

EP 1 242 210 discloses a similar method where a scanning laser is used to create a linear profile that can be directed around a radius of curvature to produce a curved shaped piece of glass. Again, a cold spot follows the linear profile, creating a crack in the glass thermally without the use of additional mechanical force or stress to initiate the crack.

Each of these methods has disadvantages. Mechanical cutting alone can result in stressed edges and glass splinters around the crack region. Methods involving heating the glass and applying a mechanical stress to initiate the crack require two cutting devices to be placed alongside the glass ribbon in the float line. Laser cutting, whilst requiring only a single cutting device and reducing splinter due to mechanical stress cannot be used to cut glass having a surface coating, for example, an IR reflective coating, in situ on the float line.

There therefore exists a need to be able to cut glass ribbons, of varying thicknesses and/or having IR reflective coatings, in situ on the float line, without the need to provide both mechanical and thermal cutting devices, which is compatible with standard selvedge equipment and which results in minimum glass splinter and a near perfect glass edge.

The present invention aims to address these problems by providing a float glass cutting apparatus comprising a linear gas burner and a cooling spray, the linear gas burner and cooling spray being arranged to cause thermal stress cracking along a cutting line that extends along a moving ribbon of float glass, parallel with the edge of the ribbon, wherein the thermal stress cracking is initiated without the use of mechanical force.

Such apparatus has the advantage that a relatively low-cost heat source can be used to cut the edge from a ribbon of float glass, resulting in a near perfect edge. As a mechanical force to initiate the crack is not needed, the cutting process is simplified compared to the prior art.

Preferably, the thermal stress cracking is initiated by the burner.

The present invention also provides a float glass cutting apparatus comprising a linear gas burner and a cooling spray, the linear gas burner and cooling spray being arranged to cause thermal stress cracking along a cutting line that extends along a moving ribbon of float glass, parallel with the edge of the ribbon, wherein the thermal stress cracking is initiated by the burner.

The use of the burner to initiate the crack removes the need to use mechanical force to allow cutting to commence.

Preferably, the thermal stress cracking is initiated by increasing the power supplied by the burner to the glass.

Preferably, the linear gas burner comprises a plurality of burner nozzles. The linear gas burner may burn a mixture of a flammable gas and one of oxygen or air. In particular, the linear gas burner may burn a mixture of propane and oxygen gases. Preferably the burner nozzles are arranged in a concentric manner. The burner may comprise two rows of burner nozzles, one located on either side of the burner nozzles arranged in a concentric manner.

The invention also provides a method of cutting a continuous ribbon of float glass, comprising heating a cutting line on the glass, parallel with the edge of the ribbon, and cooling the cutting line to cause thermal stress cracking, wherein the thermal stress cracking is initiated without the use of a mechanical force.

This gives the advantage that a relatively low-cost heat source can be used to cut the edge from a ribbon of float glass, resulting in a near perfect edge.

Preferably, the thermal stress cracking is initiated by the burner.

The present invention also provides a method of cutting a continuous ribbon of float glass, comprising heating a cutting line on the glass, parallel with the edge of the ribbon, and cooling the cutting line to cause thermal stress cracking, wherein the thermal stress cracking is initiated by the burner.

The use of the burner to initiate the crack removes the need to use mechanical force to allow cutting to commence.

Preferably, the thermal stress cracking is initiated by increasing the power supplied by the burner to the glass.

The float glass may have a coating on the surface adjacent the linear gas burner. The continuous ribbon of float glass may have an infra-red reflective coating on the surface adjacent the linear gas burner.

The method may further comprise breaking the float glass along the cutting line when cracked, and, removing the cut portion from the float glass.

Float glass cut using the apparatus or the method of the invention is also provided.

The invention will now be described by way of example only, and with reference to the accompanying drawings in which:

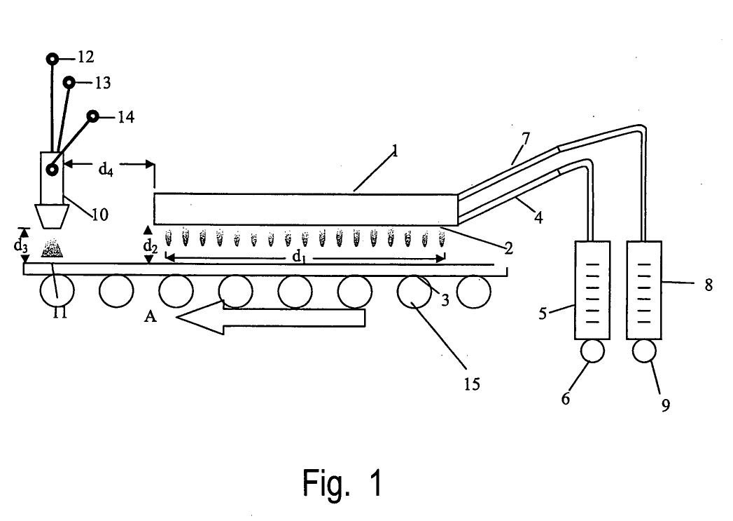

FIG. 1 is a schematic diagram of a cutting device in accordance with an embodiment of the invention; and

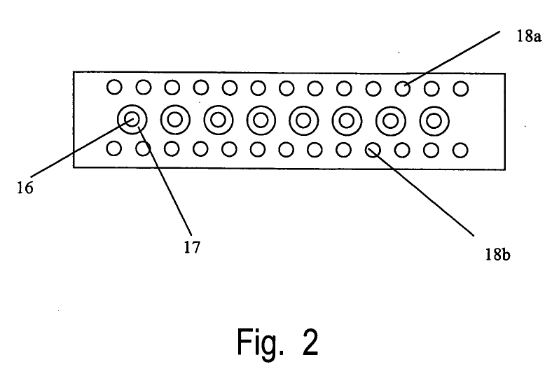

FIG. 2 is a schematic plan view of the linear burner of FIG. 1.

The present invention is concerned with the removal of selvedge from the edge of a continuous ribbon of float glass. A linear gas burner is used to heat the glass border along a cutting line, which extends along the ribbon, parallel with the edge of the glass, which is subsequently cooled by blowing a water/air mixture onto the glass. The arrangement of the linear gas burner and the water spray cause thermal stress cracking along the cutting line.

FIG. 1 shows a schematic diagram of a cutting device in accordance with an embodiment of the invention. The cutting device is positioned above the glass just in front of the cross cutters used to cut the glass to shape. A linear gas burner 1 having a length d₁ and comprising a plurality of gas burner nozzles 2 is fixed, at a distance d₂, above a continuous glass ribbon 3, moving in a direction indicated by arrow A. The linear gas burner 1 is fed by a propane supply line 4 leading from a propane cylinder 6 having a flow meter 5 and by an oxygen supply line 7 leading from an oxygen cylinder 9 having a flow meter 8. The number of gas burner nozzles and the flame profile of each nozzle are chosen to give adequate burner power to heat the cutting line sufficiently to create a score line at the cooling spot.

The cooling spot is provided by a water spray nozzle 10 that sprays a jet of water 11 from a distance d₃ onto the surface of the glass ribbon 2 once it has passed under the burner 1. The water nozzle 10 is fixed at a distance d₄ from the burner 1 and at a height d₃ above the glass surface. The water nozzle 10 is linked to a water supply 12, at ambient temperature, a first pressurized air supply 13 for switching an outlet valve on the nozzle 10 (not shown) and a second pressurized air supply 14 for atomizing the water sprayed out from the nozzle 10. The glass is supported on the lehr rollers 15.

Typical values for d₁, d₂, d₃ and d₄ are shown in Table 1 below:

TABLE 1
typical values of d₁, d₂, d₃ and d₄

| | |
|---|---|
| d₁ (length of burner) | 230 mm |
| d₂ (distance of burner above glass surface) | 10 mm |
| d₃ (distance of water spray nozzle above glass surface) | 15 mm |
| d₄ (distance between burner and water spray nozzle) | 250-300 mm |

In order to initiate a cut, a crack, caused by the thermal stresses within the glass from the heating and cooling processes, must be induced in the glass at the point of the cutting line. In order to create a thermal stress crack, the burner power is increased for a short period of time until a crack is initiated, and then reduced to the level needed to propagate the crack along the cutting line. The thermal stress crack is initiated without the use of mechanical force. The thermal stress crack forms a score line, enabling the removal of the edge of the glass using standard selvedge removal equipment, located further down the float line. Once the thermal stress crack has been formed, the cut portion is removed. The power per unit length supplied by the burner is preferably nearly constant along the length of the burner. In order to avoid the formation of glass splinters, the power per unit length supplied by the burner must not exceed a value where the glass splinters. The burner provides a nearly constant distribution of applied thermal energy along the cutting line, and the temperature of the glass surface increases along the length of the burner.

As shown in FIG. 2, the oxygen outlets 17 and propane outlets 16 of the linear burner are arranged in a concentric manner in order to achieve the narrow flame shape and temperature required to cut the glass. On both sides of the row of concentric nozzles are two rows of nozzles 18a, 18b supplying oxygen for improving the flame geometry (not shown). These additional nozzles burn oxygen, and are used to control the flame profile. The burner typically burns oxygen and propane, although any suitable flammable gas can be mixed with air or oxygen and burned instead.

Table 2 below summarises the results of four trials to cut different types and thickness of float glass ribbon during production.

TABLE 2
Results of trials of a cutting device
embodying the present invention

| | | Sample | Sample | Sample | Sample |
|---|---|---|---|---|---|
| | Unit | 1 | 2 | 3 | 4 |
| Glass Type | | bronze/ | clear | IR- | low- |
| | | clear | | reflective | iron |
| | | | | coated | |
| Glass | mm | 4.6 | 4 | 6 | 19 |
| Thickness | | | | | |
| Lehr Roller | m/min | 5.2 | 8.4 | 8.4 | 1.9 |
| Speed | | | | | |
| Burner | kW | 1.9-2.4 | 2.9 | 2.1 | 2.2 |
| Thermal | | | | | |
| Power | | | | | |
| Normalised | l/h | 73-95 | 113 | 122 | 86 |
| Propane Flow | | | | | |
| Oxygen Flow | l/h | 1570-1630 | 1630 | 1630 | 1630 |

Each of Sample 1, Sample 2 and Sample 3 were cut successfully using the burner and water spray and the edge removed using standard selvedge removal equipment. Sample 1 was a ribbon of glass having a bronze to clear tint. Sample 2 was clear float glass.

Sample 3 was a ribbon coated with an infra-red reflective coating on its upper surface. The successful cutting of the ribbon represents a great advance over laser cutting techniques as it is not possible to cut glass having an IR reflective coating using a laser incident on the coated side (top side) of the glass. One possible reason for this is that a laser transmits the majority of its energy to the glass via radiation and a greater part of this energy is reflected by an IR reflective coating before being able to heat the glass. In the case of the linear gas burner, the energy is transmitted via convection, conduction and radiation.

The trial to evaluate the cutting of Sample 4 consisting of a low-iron content extra clear float glass resulted in a visible score line allowing manual removal of the edge. Standard selvedge removal equipment was not used.

In each trial, the resulting cut edge was near perfect. A further advantage of the use of the burner is that the cutting process is able to cope with a wide range of temporary or residual stress within the glass.

The ability to cut the glass depends on the geometry of the burner and water nozzle set-up, and the power delivered by the burner to the glass. The flame profile is also an important factor. The power supplied, distance between the burner and the glass, distance between the burner and the water nozzle and the flame geometry (shape of each flame) are all optimised for each glass thickness and different lehr speeds. In order to ensure that the crack in the glass does not open up before the glass reaches the selvedge removal equipment (located downstream from the lehr rollers), it may also be necessary to alter the height of the cross-breaking device used to cut the glass before the selvedge is removed, as well as adjust the burner and water nozzle settings.

1. A float glass cutting apparatus comprising a linear gas burner and a cooling spray, the linear gas burner and cooling spray being arranged to cause thermal stress cracking along a cutting line that extends along a moving ribbon of float glass, parallel with the edge of the ribbon, wherein the thermal stress cracking is initiated without the use of mechanical force.

2. The float glass cutting apparatus of claim 1, wherein the thermal stress cracking is initiated by the burner.

3. A float glass cutting apparatus comprising a linear gas burner and a cooling spray, the linear gas burner and cooling spray being arranged to cause thermal stress cracking along a cutting line that extends along a moving ribbon of float glass, parallel with the edge of the ribbon, wherein the thermal stress cracking is initiated by the burner.

4. The float glass apparatus of claim 3, wherein the thermal stress cracking is initiated by increasing the power supplied by the burner to the glass.

5. The float glass cutting apparatus of claim 1, wherein the linear gas burner comprises a plurality of burner nozzles.

6. The float glass cutting apparatus of claim 5, wherein the linear gas burner burns a mixture of a flammable gas and one of oxygen or air.

7. The float glass cutting apparatus of claim 6, wherein the linear gas burner burns a mixture of propane and oxygen gases.

8. The float glass cutting apparatus of claim 5, wherein at least some of the burner nozzles are arranged in a concentric manner.

9. The float glass cutting apparatus of claim 8, wherein the burner comprises two rows of burner nozzles, one located on either side of the burner nozzles arranged in a concentric manner.

10. A method of cutting a continuous ribbon of float glass, comprising:
heating a cutting line on the glass, parallel with the edge of the ribbon, and cooling the cutting line to cause thermal stress cracking,
wherein the thermal stress cracking is initiated without the use of a mechanical force.

11. The method of claim 10, wherein the thermal stress cracking is initiated by the burner.

12. A method of cutting a continuous ribbon of float glass, comprising:
heating a cutting line on the glass, parallel with the edge of the ribbon, and cooling the cutting line to cause thermal stress cracking,
wherein the thermal stress cracking is initiated by the burner.

13. The method of claim 12, wherein the thermal stress cracking is initiated by increasing the power supplied by the burner to the glass.

14. The method of claim 10, wherein the float glass has a coating on the surface adjacent the linear gas burner.

15. The method of claim 14, wherein the float glass has an infra-red reflective coating on the surface adjacent the linear gas burner.

16. The method of claim 10, further comprising breaking the float glass along the cutting line when cracked, and, removing the cut portion from the float glass.

17.-21. (canceled)
